(19) United States
(12) Patent Application Publication
(10) Pub. No.: US 2019/0320848 A1
(43) Pub. Date: Oct. 24, 2019

(54) Apparatus for Rapidly Heating or reheating french Fries

(71) Applicant: Yanis Mikos Cedric Rock, Orlando, FL (US)

(72) Inventor: Yanis Mikos Cedric Rock, Orlando, FL (US)

(21) Appl. No.: 15/960,511

(22) Filed: Apr. 23, 2018

(51) Int. Cl. A47J 37/08; B65D 81/34

(52) U.S. Cl. CPC A47J 37/0885; A23L 19/18; B65D 81/3492

(57) ABSTRACT

The present invention generally relates to a novel cooking apparatus and, more specifically to a cooking apparatus for rapidly heating or reheating French Fries. There are known methods or devices in which cooking or heating French Fries is possible. However, because these methods or devices are slow, inefficient, or messy, they do not satisfy the needs of the consumer. The present invention discloses a vented silicone sleeve comprising an opening at the top (4), handles at the top (1,1′), vents along both faces of the device (2) and spines along both edges (3). French Fries are placed in the opening (4) and the apparatus is placed in a toaster using the handles (1,1′), heat is applied to the device from the toaster and the vents (2) allow for the even heating of the fries. Once heating is complete, the handles (1,1′) is used to remove the apparatus.

### BACKGROUND OF THE INVENTION

### 1. Field of the Invention

The present invention relates to a cooking utensil, and more particularly, to an improved cooking utensil for use of heating of French fries and other foods in a silicone vented bag apparatus. The invention is substitutable for conventional methods of heating French fries which will provide further convenience, healthy cooking and users' satisfaction without compromising the desired taste or consistency of French Fries.

### 2. Description of the Related Art

Any discussion of the prior art throughout the specification should in no way be considered as an admission that such prior art is widely known or forms part of common general knowledge in the field.

The origins of the French fry have been traced back to Belgium, where historians claim potatoes were being fried in the late-1600s. According to the best available historical accounts, poor villagers living in the Meuse Valley often ate small fried fish they caught in the river. During the winter months the river would freeze over—making fishing impossible and forcing the villagers to find other sources of food.

The villagers turned to the tough root vegetable, slicing and frying it much in the same way they prepared the fish. And just like that, the earliest French fries were born. American soldiers stationed in Belgium were first introduced to French fries during World War I. As the official language of the Belgian army was French, soldiers nicknamed the delicious fried potatoes “French fries.”

French fries are one of the most popular side dishes in the world. Fries are dipped or covered in ketchup, mayonnaise, ranch dressing, ice cream, or vinegar making it a universal food that appeals to a number of different tastes.

There are multiple inventions in this regard that focus on making French fries. For instance, a U.S. Pat. No. 4,198,437 issued to Ore-Ida Foods Inc implies a procedure for creating delicious French fries where an elongated potato product simulating a French fry and provided with a plurality of serrated, longitudinal ridges alternating with longitudinal valleys, is formed by extrusion of a potato mix through a suitable die. The serrations of the ridges provide a multiplicity of individual projections more or less resembling spicules, which are completely exposed to hot fat during initial frying of the product prior to freezing and to applied heat during reconstitution of the frozen product. This results in French fries of superior quality. The spicules are a result of proper consistency of the mix and configuration of the extrusion die.

Another U.S. Pat. No. 5,308,640 implied a method where reduced calorie French fries and other high moisture fat-coated foods having less greasiness method is disclosed. Such products are typically obtained by applying to the surface of the French fry, or other food, reduced calorie fat compositions having particular fluid viscosity characteristics that correlate to reduced greasiness impressions. These reduced calorie fat compositions comprise a non-absorbable fat, and optionally, a triglyceride fat or oil. The fat in general comprises a liquid non-digestible oil and a sufficient amount of a solid polyol polyester to control passive oil loss typically associated with the ingestion of liquid non-absorbable oils.

According to U.S. Pat. No. 5,997,938 issued to Proctor and Gamble Co is the invention that provides a process for quickly oven finishing (baking) oil-enrobed prebake fries in a 0.75 minute at a temperature of from about 325° F. (162° C.) to about 800° F. (426° C.) to provide oven-finished French fries that have virtually the same taste and characteristics as deep fat fried finished French fries. The oven-finished shoestring French fries of this invention are characterized as having: a bulk moisture of from about 32% to about 46%; a total fat content of from about 12% to about 25%; and a French Fry Texture Value of at least about 200. Preferably the fries have a surface water activity (Aw) of less than about 0.55 and an internal moisture content of from about 55% to about 80%.

From extensive research it has been found that reheating French fries is a common problem for people from all walks of life. French fries as a food are most desirable when they are hot in temperature, have a soft interior consistency and a crispy outer consistency. However, there are no such specialized devices where French Fries can be reheated without compromising on their freshness, crispiness, and taste.

Accordingly, a need exists for a unique utensil capable of reheating French fries. Currently, there is no efficient method for rapidly reheating fries and simultaneously maintain the requisite consistency of them. The development of this vented bag will prove a significant improvement to the current methods for reheating fries. It will allow the user to reheat a ½ cup of fries in 1 minute in their standard toaster and restore a crispy outside and a soft and hot interior. Moreover, this utensil will reduce the need for additional grease to be added in other methods while being easily stored and cleaned.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### BRIEF SUMMARY OF THE INVENTION

In light of the disadvantages of the previous inventions, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary object of the invention is related to a method to conveniently and rapidly heat or reheat French fries and simultaneously maintain the requisite taste and consistency of them.

The invention will also provide the consumers a superior utility by providing an apparatus which doesn't require any oil for reheating the cooked product.

The invention also aims to provide an apparatus whose material can be used for an extensive period of time without threat of any health hazard or reduction in durability or effectiveness.

Another object of the invention is aimed at providing apparatus which is resistant to high temperatures, dishwasher safe, food safe after multiple uses, and easy to use.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows a front view of the invention.

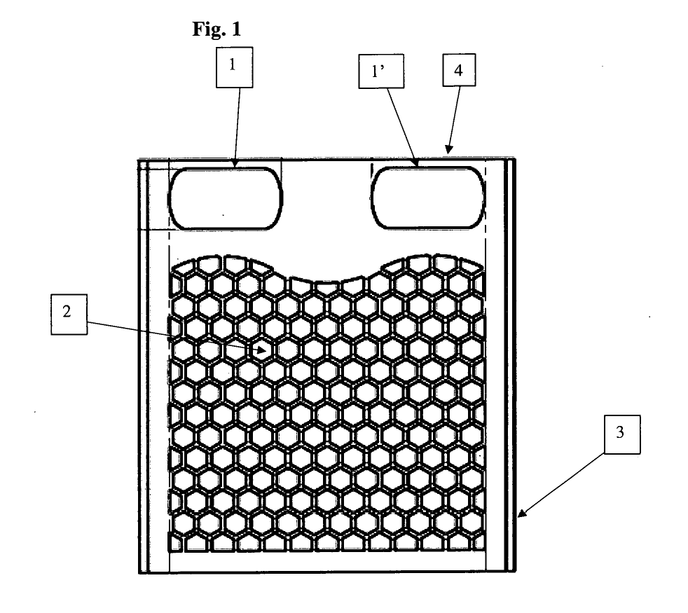

FIG. 2 shows a side view of the invention.

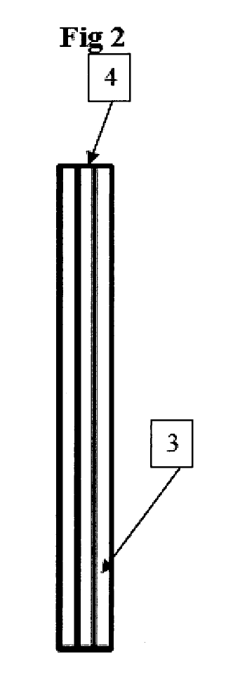

### DETAILED DESCRIPTION OF THE INVENTION

### 1. Overview

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where by conventional symbols in the drawings, showing only those specific details that are pertinent to understanding the embodiments of the present invention so as not to obscure the disclosure with details that will be readily apparent to those of ordinary skill in the art having the benefit of the description herein.

### 2. In Use

The user inserts French Fries in the opening 4 and utilizes the handles 1,1′ to place the device into a toaster. The openings or vents 2 on both faces of the apparatus allows for heat to pass though device for the even heating of French Fries. The spines 3 along the edges reinforce the structure of the apparatus and provides additional durability and rigidity. Once the heating cycle completes and the apparatus containing the heated French Fries pops up, the user will once again utilize the handles 1 to safely remove it from the toaster and pours the heated French Fries out of the opening 4.

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The present invention relates to an apparatus which is designed to provide speed, convenience, and healthy cooking while reheating French Fries. The current invention is a silicone vented bag for reheating French Fries in a toaster

The current invention in its preferred embodiment signify an apparatus which has proven a significant improvement to the current methods for reheating fries. It allows the user to reheat a ½ cup of fries (in a standard bread toaster) and restore a crispy outside and soft, hot interior.

The invention in its preferred embodiment details an apparatus which is made completely of silicone or comparable material and is made to fit into a standard bread toaster. The specialized handles were designed to aid in the safe removal of the French Fries from a hot toaster. It has a rectangular frame with 2 netted faces that allow for the even heating of French fries in a simple, single-part design.

The utensil itself is preferably made of high quality Silicone, it being understood that the material used to fabricate the utensil should be stable against deformation by exposure to high temperatures and repeated compression during the cooking process, and prolonged wear and tear through normal use.

In a preferred form, the apparatus is generally a flat angular shaped in which the fries are heated. Also, the dual wall arrangement constitutes a splatter proof shield which quickly withdraws greases from the products being cooked. The apparatus is provided with handles on the top which makes it easy to insert, remove and carry the device by the user.

While a specific embodiment has been shown and described, many variations are possible. With time, additional features may be employed. The particular shape or configuration of the platform or the interior configuration may be changed to suit the system or equipment with which it is used.

Having described the invention in detail, it is understood that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I claim:

1: The present invention is a vented bag for heating French fries in a toaster comprising:
(a) a vented bag made completely of silicone;
(b) a French Fries reheating vented bag made to fit into a standard bread slice toaster;
(c) a vented bag which has a handle on its top to easily and safely remove the device from toaster.

2: A French Fries reheating vented bag according to claim 1,
(a) where according to claim 2, the vented bag will carry the French fries;
(b) where according to claim 2, the vented bag will be inserted in toaster for heating French Fries;
(c) where according to claim 2, the device is placed in a vertical position inside the toaster with handles pointed up
(d) where according to claim 2, the vented bag can accommodate ½ cup of French fries
(e) where according to claim 2, the vented bag has an opening at the top to accommodate French Fries

3: A French Fries heating apparatus which is durable as made of high quality silicone or comparable materials and is food safe, temperature resistant, dishwasher safe, and durable.

4: A heating apparatus that can be used to heat or reheat other foods in a standard bread toaster where other methods of heating are limited in their effectiveness.
